(19) United States
(12) Patent Application Publication
(10) Pub. No.: US 2007/0158503 A1
(43) Pub. Date: Jul. 12, 2007

(54) Fluid dynamic foil with Coanda energizer

(76) Inventor: Donald E. Burg, Miami, FL (US)

Correspondence Address: Donald E. Burg, 15840 SW 84 Avenue, Miami, FL, 33157, US

(21) Appl. No.: 11/330,845

(22) Filed: Jan. 12, 2006

(51) Int. Cl. B64C 3/50

(52) U.S. Cl. 244/215

(57) ABSTRACT

Presented is an improved concept airfoil, or more properly called fluid dynamic foil, that promises coefficients of lift several times better than present day airfoils or hydrofoils. This is accomplished by use of a rotary Coanda fluid accelerator that is part of the boundary of a high camber or fat airfoil shape. Acceleration of oncoming fluids over the low static pressure side of the airfoil by the rotary element not only decreases the static pressure thereby increasing lift but also improves flow characteristics over the low static pressure side of the airfoil which reduces or eliminates flow separation and its associated turbulent drag effects. Alternative ways to eliminate the flow separation are also presented as well as are ways to control the angle of attack of the airfoil. The concept presented is applicable to aircraft wings, rotary wings such as used on helicopters, hydrofoils, wind and water turbine blades, and the like.

### BACKGROUND OF THE INVENTION

Airfoils are, of course, essential to flight through air and hydrofoils through water. A better name that works in any fluid medium would be Fluid Dynamic Foils (FDF) and that name is used herein to signify use of foils in any fluid medium. Much work has been done in the development of airfoils over the years. One of the more interesting developments was the early work on high camber or fat airfoils done in the thirties. These high camber airfoils demonstrated Coefficients of Lift (CL) of 4 to 4.5 at angle of attacks (∝) of 5-10 degrees when enhanced by Boundary Layer Control (BLC). This compares to a C_{L} of only about 1.6 at the same ∝'s for present day airfoils. This would indicate that use of high camber airfoils with BLC would result in about 2.5 times the C_{L} of present day airfoils or hydrofoils.

A good source of background in this area is from FIG. 138, page 233 of “Theory of Wing Sections” by Abbott and Von Doenhoff, © 1959, Library of Congress No: 60-1601 Published by Dover Publications, Mineola, N.Y. BLC can be accomplished by either aspirating or expelling air from slots in the upper surface of the airfoil proximal the location where flow separation would normally begin. These BLC means, if implemented properly, eliminates the flow separation and its associated high drag turbulence over the airfoil and hence makes them workable. Demonstration tests were done using blowers to do the BLC fluid work and showed that C_{L}'s up to 5 were obtainable. Unfortunately, the complexity and weight of the associated blowers relegated this technology to the dustbin of history.

What is presented in the instant invention is a means to accelerate fluids over a FDF such that even higher velocities, and hence lower static pressures and higher C_{L}'s, over an airfoil's or hydrofoil's upper surface than those demonstrated with the high chamber airfoils in the earlier work. This is done by means of a forward disposed rotary element that is at least part of the FDF's shape. Rotation of the rotary element, by means of the well known Coanda Effect, accelerates fluid over the upper surface of the FDF. This acceleration of fluids over the upper surface of the FDF will result in even lower static pressures and hence a higher C_{L} than demonstrated heretofore in the prior art.

It is possible that no BLC will be required when the Coanda Effect rotary element is employed. However, the rotary element may be utilized to supply the work to accomplish BLC. In such instance the rotary element does the fluid energizing required for BLC during its normal rotation. Ways to accomplish changes in ∝ are possible by either rotating portions of the FDF around the rotary element or by rotating the entire FDF including the rotary element as a unit.

### SUMMARY OF THE INVENTION

With the foregoing in mind, it is a principal object of the present invention to provide an improved fluid dynamic foil that offers greater efficiencies than the prior art by having a rotary element to add acceleration to fluids traveling over the low pressure side of the fluid dynamic foil thereby reducing the static pressure further and enhancing the coefficient of lift of the fluid dynamic foil and whereby said rotary element makes up-part of the boundary of the fluid dynamic foil.

A related object of the invention is- that the rotary element be disposed proximal a forward end of and wherein an aft end of said fluid dynamic foil completes at least a majority of the trailing end of a generally elongated foil shape.

A related object of the invention is that the rotary element may be fully or partially driven by artificial means that may be in the form of a powering rotatable device.

A further object of the invention is that the rotary element may be fully or partially driven by rotational energy supplied by a fluid turbine where said fluid turbine obtains at least part of its energy from fluid passing by the fluid dynamic foil.

Yet another object of the invention is that said improved fluid dynamic foil, including its rotary element, have a maximum camber as measured in percent of chord length of at least seven percent.

A further related object of the invention is that said fluid dynamic foil, including its rotary element, have a maximum camber as measured in percent of chord length of at least nine percent.

Yet another related object of the invention is that said fluid dynamic foil, including its rotary element, have a maximum camber as measured in percent of chord length of at least eleven percent.

Another object of the invention is that fluid energized by the rotary element may be directed through a fluid passageway with said fluid passageway discharging fluid through an exit opening in the low static pressure surface.

A directly related object of the invention is that said exit opening in the low static pressure surface of the fluid dynamic foil be disposed, at least in its majority, aft of mid-span of the improved fluid dynamic foil.

Yet another object of the invention is that a fluid passageway may be, at least in its majority, positioned upstream of a fluid labyrinth seal.

A further object of the invention is that a fluid passageway may connect the low static pressure surface and a fluid energizing chamber positioned proximal the rotary element thereby aspirating fluid from the low static pressure surface.

Still another object of the invention is that an aft portion of the fluid dynamic foil may rotate about the rotary element.

A directly related object of the invention is that power for rotation of an aft portion of the fluid dynamic foil may be supplied by artificial means.

A further object of the invention is that trim control of the fluid dynamic foil may be accomplished by flap-like devices.

### BRIEF DESCRIPTION OF THE DRAWINGS

FIG. 1 shows a generic airfoil shape such as is most commonly used today as the shape of aircraft wings, helicopter rotary wings, wind turbine rotor blades, hydrofoils, etc. The instant invention is intended to work in all fluid media.

FIG. 2 presents a prior art fat or high camber airfoil shape that would offer substantially higher C_{L}'s than the slim airfoil given in FIG. 1 except that, due to its high amount of camber and hence fat shape, would experience separation of the fluid flow over its aft end.

FIG. 3 shows one way to do BLC and thereby avoid the turbulent flow separation seen in the FIG. 2 airfoil. This is done in this prior art by aspirating or sucking in fluid proximal where separation turbulence would normally begin.

FIG. 4 shows another way to avoid the turbulent drag. In this prior art case it is accomplished by expelling fluid proximal where the turbulent separation would normally begin.

FIG. 5 presents a basic variant of the instant invention whereby a rotary element is placed as a forward portion of the shape of the airfoil or FDF. In this instance the rotary element accelerates fluid by means of the Coanda Effect over the upper surface of the FDF. This acceleration of the fluid means that a higher velocity and lower static pressure results over the FDF's upper surface as is well defined by Bernoulli's equations. The simple and low cost approach suggested here gives even higher efficiencies, due to higher velocities and related lower static pressures, than the fat or high camber airfoil shapes of FIGS. 2-4. It should be possible that this can be accomplished without BLC; however, provision to do BLC simply and at low cost is presented in following figures and their discussions. Note that the BLC openings are best located proximal where fluid separation and turbulence would start with that position normally being aft of mid point on the high velocity and low static pressure side of the FDF.

FIG. 6 presents a way to control ∝ of the FDF by simply rotating an aft portion of the FDF in relation to the rotating element. In this case it is rotated down to give an increased ∝.

FIG. 7 simply shows rotation of the aft portion of the FDF upward which results in a negative ∝.

FIG. 8 is a topside plan view of a preferred embodiment of the instant invention in the shape of a tapered wing.

FIG. 9 is a cross-section, as taken through plane 9-9 of FIG. 8 that shows, in addition to the rotary element as part of the FDF, a way to accomplish BLC by expelling fluid to the upper surface of the FDF. Note that fluid used for BLC is preferably pumped or energized here by the rotary element to insure simplicity of the concept. It is also possible to supply BLC pumping means as separate apparatus other than use of the rotary element and that is considered within the spirit and scope of the invention.

FIG. 10 presents a cross-section, as taken through plane 10-10 of FIG. 8, that shows how the rotary element can be integrated structurally with the full FDF. This is done by way of ball bearings, however, other ways of providing separate movement of the rotary element from the aft body of the FDF, such as fluid bearings, sleeve bearings, etc., are considered within the scope and spirit of the invention.

FIG. 11 is a cross-section, as taken through plane 11-11 of FIG. 8, that shows a means to power the rotation of an aft portion of the FDF around the rotary element.

FIG. 12 presents a cross-section, as taken through plane 12-12 of FIG. 8, that illustrates a way to drive the rotary element by means of a fluid turbine. That fluid turbine, while shown at the extreme or outward end of the FDF in FIG. 8, may be positioned anywhere along the length of the FDF. It would be best located where shown when the instant invention FDF is used in a rotary wing application such as is the case of the rotary wing of a helicopter or wind or water turbine blade. The reason for this is that the extreme of such rotary wings are traveling at the highest velocity and hence have the most fluid energy available to drive a turbine or other apparatus.

FIG. 13 shows a cross-section as taken though the same plane as 9-9 of FIG. 8 but in this instance the concept is to aspirate fluid into the FDF to accomplish BLC.

FIG. 14 shows the outline of a rotary element as would be used in a tapered FDF wing that was presented in FIG. 8.

FIG. 15 presents another variation of the instant invention where the complete FDF including its rotary element rotate in unison. This is presented since it would be an inherently structurally stronger design than the instant invention FDF presented in the earlier figures. Either the means to control ∝ presented in FIG. 8 or FIG. 15 can be employed and either is considered within the spirit and scope of the instant invention.

FIG. 16 is a cross-section, as taken though plane 16-16 of FIG. 15, that shows how trim can be accomplished by use of flaps.

FIG. 17 shows a rotary element as might be used in a straight FDF wing version of the instant invention as was presented in FIG. 15.

### DETAILED DESCRIPTION

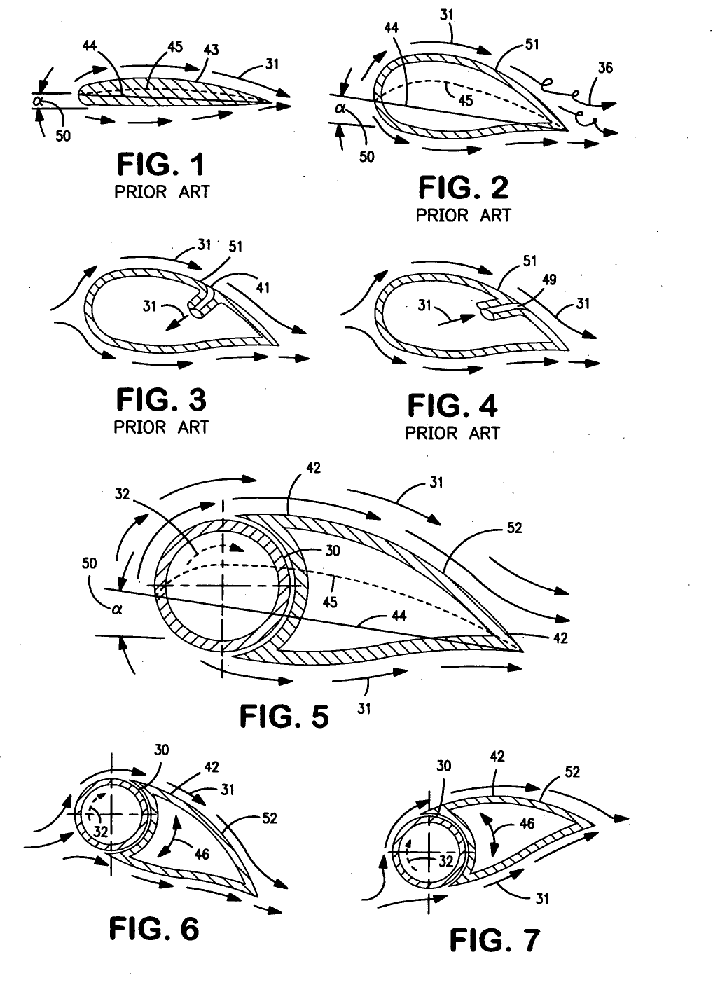

FIG. 1 shows a generic rather thin airfoil or Fluid Dynamic Foil (FDF) 43 and its air or fluid flow lines 31 that is operating at angle of attack ∝ 50. This type airfoil is what is most commonly used today as the shape of aircraft wings, helicopter rotary wings, wind turbine rotor blades, hydrofoils, etc. By measurements of the length of the chord line 44 and maximum deviation from the chord line of the mean camber line 45 it can be established that the maximum deviation of the camber line as a percentage of chord line is about two percent in this example. This percentage is given as the first digit in the four digit NACA designation of airfoil shapes. For general background information, when a four digit NACA designation is given, it is defined as: 1) First digit=maximum camber in percent of chord, 2) Second digit=location of position of maximum camber in percent of chord as measured from the leading edge of the airfoil, and 3) Last two digits=maximum thickness of the airfoil in percent of chord. The FIG. 1 airfoil therefore would have a designation of NACA 2414.

The figures presented in this application normally show airfoils or FDF's horizontally oriented. It is to be realized that it is within the spirit and scope of the invention that they may be oriented vertically or at any other angle including a rotation of 180 degrees from the orientation of the figures as presented.

FIG. 2 presents a prior art fat or high camber FDF 51 that would offer substantially higher C_{L}'S than the slim airfoil given in FIG. 1 except that, due to its high amount of camber and hence fat shape, would experience separation of the fluid flow over its aft end as is indicated by turbulent fluid flow lines 36. Due to its very high degree of camber and hence its fat shape this particular example has a maximum camber as percent of chord of about 15. As such it would not even fit into the NASA four digit designation. Assuming it a slimming down to a maximum camber as percent of chord designation of a single digit of nine, the designation would be: NACA 9346. As can be seen we are dealing with a whole different set of dimensions here compared to the FIG. 1 thin airfoil.

FIG. 3 shows a way to do Boundary Layer Control (BLC) and to avoid the turbulent flow separation seen in the FIG. 2 high camber FDF. This was done in prior art tests by aspirating or sucking in fluid through BLC bleed opening 41 proximal where turbulence and flow separation would normally begin.

FIG. 4 shows another way to avoid the turbulent separation drag. In this prior art case test case it is accomplished by expelling fluid through BLC discharge opening 49 disposed proximal where the turbulent separation would normally begin. What the prior art examples given in FIGS. 3 and 4 do is reduce or eliminate the drag values associated with turbulent separation flow patterns. The FIG. 3 and 4 Coefficient of Lift (C_{L}) has been measured in the 4-4.5 area which is about 2.5 times greater than the C_{L} of 1.6 or so experienced by the more accepted thin airfoil presented in FIG. 1. A main reason that the fat high camber airfoils have not seen acceptance is because of the weight, cost, and complexity of the blowers and their powering means required to do the air or fluid pumping.

Referring back to the discussion of FIG. 2, it is considered that a preferred maximum camber as percent of chord of at least seven is called for in the case of the instant invention FDF 42 with a value of at least nine more normal and a value of eleven or higher giving best results.

FIG. 5 presents a basic variant of the instant invention whereby a rotary element 30 is placed as a forward portion of the shape of the high camber airfoil or FDF 42. The high camber FDF's aft portion 52 makes up the rest of the FDF 42. In this instance the rotary element 30 accelerates fluid by means of the Coanda Effect over the upper surface of the FDF 42 as it rotates as indicated by rotational arrow 32. This acceleration of oncoming fluid means that a higher velocity and lower static pressure results over the upper surface of this high camber FDF 42 as is well defined by Bernoulli's equations. The simple and low cost approach suggested here gives even higher efficiencies, due to higher velocities and related lower static pressures, than the high camber fat or high camber FDF shapes of FIGS. 2-4. It is expected that an overall efficiency gain of 25-30 percent can be realized compared to the prior art of FIGS. 2-4 which would mean a C_{L} of 5-6 may be realized. That C_{L} is 3 to 4 times that of the present day state of the art thin airfoils. It should be possible that this can be accomplished without BLC; however, provision to do BLC simply and at low cost, ideally in the preferred embodiment of the instant invention by using energy supplied by the rotary element 30, is presented in following figures and their discussions.

FIG. 6 presents a way to control ∝ of the FDF 42 by simply rotating an aft portion 52 of the FDF 42 in relation to the rotating element 32 as is shown by rotation arrow 46. In this case it is rotated down to give an increased ∝.

FIG. 7 shows rotation of aft portion 52 of FDF 42 upward which gives in a negative ∝.

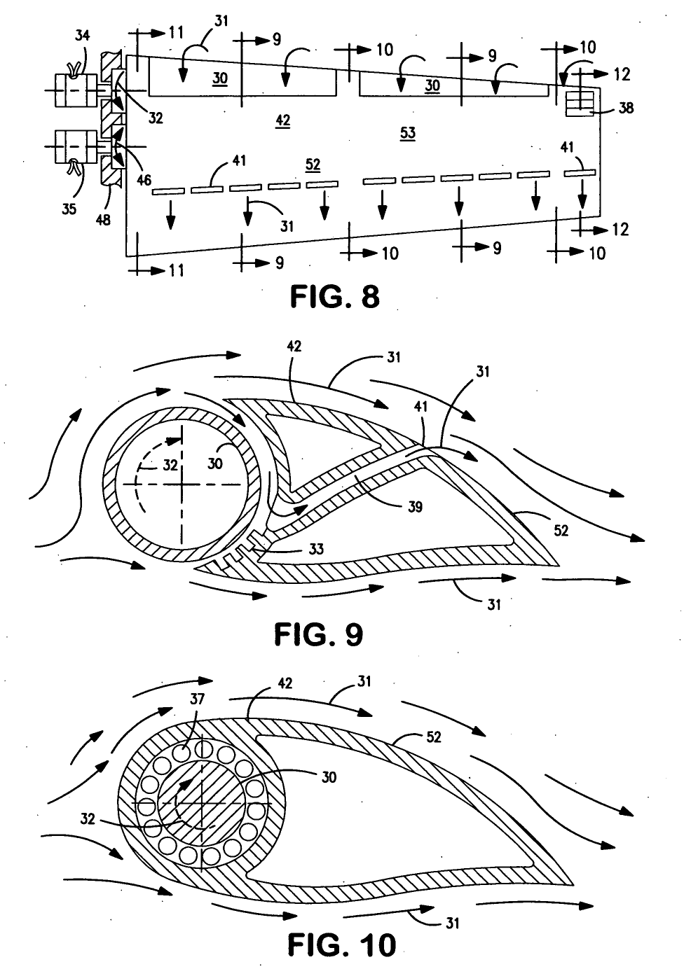

FIG. 8 is a topside plan view of a preferred embodiment of the instant invention in the shape of a tapered wing 53. A rotary element 30 drive motor 34, FDF aft portion 52 drive motor 35, portion of attached body 48, and optional turbine drive means 38 are shown. Note that the fluid discharge openings or exits 41 are in the form of longitudinally oriented slots in this wing 53. Slots are normally preferred over round openings since they spread the fluid flow that reduces turbulence over the wing more evenly. Slots may be staggered, angled, or oriented in other ways.

FIG. 9 is a cross-section, as taken through plane 9-9 of FIG. 8 that shows, in addition to the rotary element 30 as part of the FDF 42, a way to accomplish BLC by expelling fluid to the upper surface of the FDF 42. Note that fluid used for BLC is preferably pumped or energized here by the rotary element 30 to insure simplicity of the concept. The fluid being pumped by the rotary element 30 is restrained by labyrinth seal 33, or other flow restricting means, so that its majority is directed to passageway 39 to fluid exit 41. It is also possible to supply BLC fluid pumping means as separate items, not shown here, than use of the rotary element 30 and that is considered within the spirit and scope of the invention.

It is important to note the fluid flow arrows 31 forward of the rotary element 30. These show the fluid approaching the rotary element 30 to be induced to turn upward rather than divided more evenly top and bottom as was seen in the high camber prior art airfoils of FIGS. 2, 3, and 4. This feature not only increases flow over the top of the FDF 42 but also increases the velocity of the fluid where it first encounters the forward end of the FDF 42. What this means is that there is a lower static pressure at the forward end of the FDF 42 and hence a lower overall drag component compared to the prior art high camber airfoils of FIGS. 2, 3, and 4.

FIG. 10 presents a cross-section, as taken through plane 10-10 of FIG. 8, that shows how the rotary element 30 can be integrated structurally with the full FDF 42. This is done by way of ball bearings 37 here, however; other ways of providing separate movement of the rotary element 30 from the FDF's aft body 52 such as fluid bearings, sleeve bearings, etc. that, while not shown, are considered within the scope and spirit of the invention.

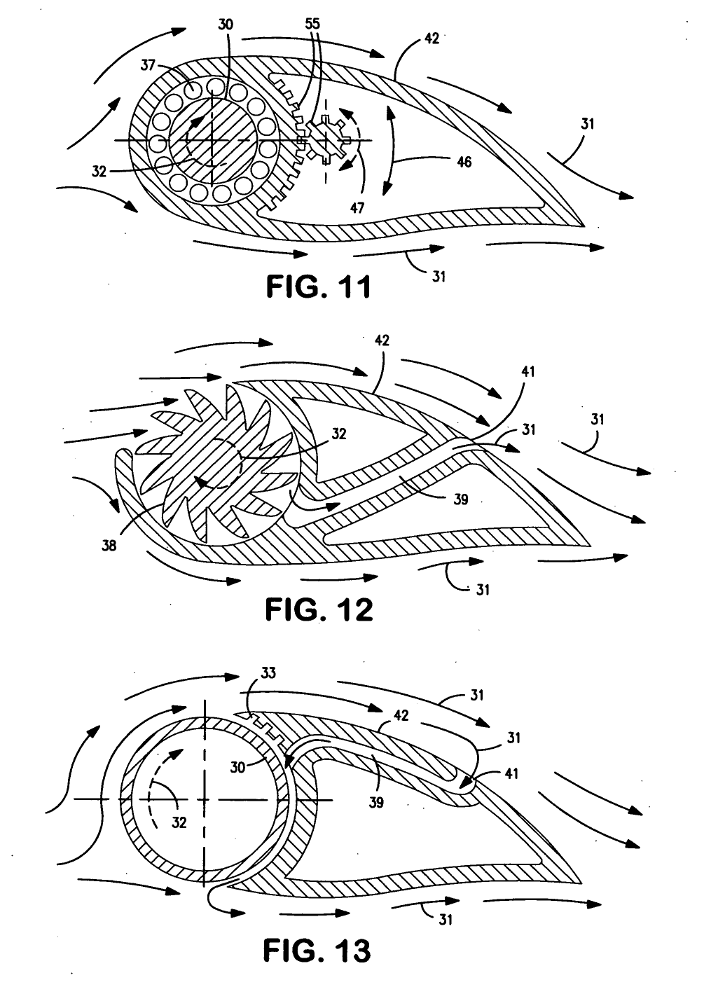

FIG. 11 is a cross-section, as taken through plane 11-11 of FIG. 8, that shows a means to power the rotation of the FDF's aft portion 52 around the rotary element 30. This is done here by means of a rack and pinion gear 55 with said gear's rotation arrow 47 also shown. Other means of rotating the FDF's aft portion 52 such as hydraulic actuators, or the like, while not shown, are considered within the scope and spirit of the invention.

FIG. 12 presents a cross-section, as taken through plane 12-12 of FIG. 8, that illustrates a way to drive the rotary element 30 by means of an optional fluid turbine 38. That fluid turbine 38, while shown at the extreme or outward end of the FDF 42 in FIG. 8, may be positioned anywhere along the length of the FDF. It would be best located where shown when the instant invention FDF 42 is used in a rotary wing application such as is the case of the rotary wing of a helicopter or wind turbine blade. The reason for this is that the extreme of such rotary wings are traveling at the highest velocity and hence have the most fluid dynamic energy available to drive them.

FIG. 13 shows a cross-section as taken though the same plane of the high camber FDF 42 as 9-9 of FIG. 8 but in this instance fluid is aspirated into the FDF 42 to accomplish BLC. Note that a labyrinth seal 33 is positioned further forward here to allow the rotary element 30 to work on low pressure incoming fluid rather than building up pressure as in the version shown in FIG. 16.

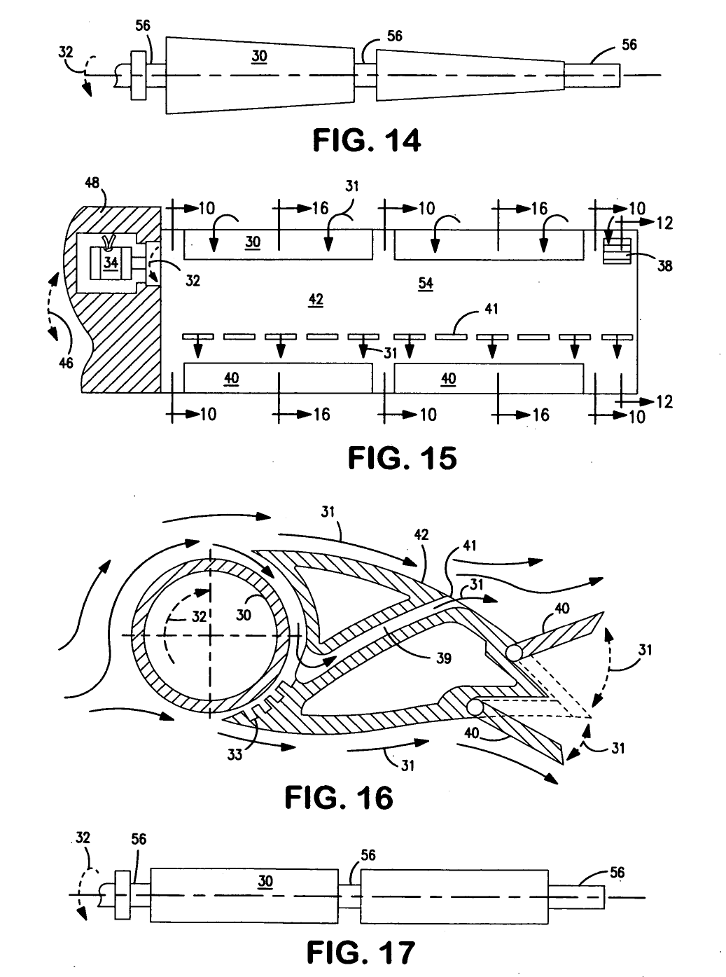

FIG. 14 shows the outline of a rotary element 30 as would be used in a tapered FDF wing that was presented in FIG. 8. The smaller diameter areas 56 are bearing seats in this version.

FIG. 15 presents another variation of the instant invention where the complete FDF 42 including its rotary element rotates about their attachment structure 48 in unison. This is presented since, while not as elegant as that presented in FIG. 8 where only the FDF's aft portion is used for trim control, it would be an inherently structurally stronger design than the instant invention FDF presented in the earlier figures. Either the means to control ∝ presented in FIG. 8 or FIG. 15 can be employed and either is considered within the spirit and scope of the instant invention.

FIG. 16 is a cross-section, as taken though plane 16-16 of FIG. 15, that shows how trim can be accomplished by use of flaps 40.

FIG. 17 shows a rotary element 30 as might be used in straight FDF wing version of the instant invention as was presented in FIG. 15.

While the invention has been described in connection with a preferred and several alternative embodiments, it will be understood that there is no intention to thereby limit the invention. On the contrary, there is intended to be covered all alternatives, modifications, and equivalents as may be included within the spirit and scope of the invention as defined by the appended claims, which are the sole definition of the invention.

What I claim is:

1. In an improved fluid dynamic foil, the improvement comprising:
a rotary element disposed proximal a forward end of and comprising part of a boundary of the fluid dynamic foil, wherein an aft end of said fluid dynamic foil completes at least a majority of the trailing end of a generally elongated foil shape, and wherein rotation of said rotary element aids in accelerating fluids over a low static pressure surface disposed opposite a high static pressure surface of the fluid dynamic foil thereby providing a resultant force on the fluid dynamic foil that is in a direction from the high static pressure surface to the low static pressure surface.

2. The improved fluid dynamic foil of claim 1 wherein said rotary element is, at least partially, driven by a rotatable drive device.

3. The improved fluid dynamic foil of claim 1 wherein said rotary element is, at least partially, driven by a fluid driven turbine like device that is coupled to the rotary element.

4. The improved fluid dynamic foil of claim 1 wherein said improved fluid dynamic foil, including its rotary element, has a maximum camber as measured in percent of chord length of at least seven percent.

5. The improved fluid dynamic foil of claim 1 wherein said improved fluid dynamic foil, including its rotary element, has a maximum camber as measured in percent of chord length of at least nine percent.

6. The improved fluid dynamic foil of claim 1 wherein said improved fluid dynamic foil, including its rotary element, has a maximum camber as measured in percent of chord length of at least eleven percent.

7. The improved fluid dynamic foil of claim 1 wherein fluid energized by the rotary element is directed through a fluid passageway and said fluid passageway discharges fluid through an exit opening in the low static pressure surface.

8. The improved fluid dynamic foil of claim 7 wherein said exit opening in the low static pressure surface is disposed, at least in its majority, aft of mid-span of the improved fluid dynamic foil.

9. The improved fluid dynamic foil of claim 7 wherein energized fluid supplied to said fluid passageway comes from, at least in its majority, a fluid energizing chamber positioned proximal the rotary element and upstream of a fluid labyrinth seal.

10. The improved fluid dynamic foil of claim 1 wherein a fluid passageway connects the low static pressure surface and a fluid energizing chamber positioned proximal the rotary element thereby aspirating fluid from the low static pressure surface.

11. The improved fluid dynamic foil of claim 1 wherein an aft portion of the fluid dynamic foil rotates about the rotary element.

12. In an improved fluid dynamic foil, the improvement comprising:
said improved fluid dynamic foil having a rotary element proximal its forward portion wherein rotation of said rotary element increases fluid velocity over the low static pressure side of the fluid dynamic foil thereby decreasing static pressure further resulting in a higher coefficient of lift for the fluid dynamic foil and said fluid dynamic foil having a maximum camber as measured in percent of chord length of at least seven percent.

13. The improved fluid dynamic foil of claim 12 wherein said rotary element is, at least partially, driven by a rotatable drive device.

14. The improved fluid dynamic foil of claim 12 wherein said rotary element is, at least partially, driven by a fluid driven turbine like device that is coupled to the rotary element.

15. The improved fluid dynamic foil of claim 12 wherein said improved fluid dynamic foil, including its rotary element, has a maximum camber as measured in percent of chord length of at least nine percent.

16. The improved fluid dynamic foil of claim 12 wherein said improved fluid dynamic foil, including its rotary element, has a maximum camber as measured in percent of chord length of at least eleven percent.

17. The improved fluid dynamic foil of claim 12 wherein fluid energized by the rotary element is directed through a fluid passageway and said fluid passageway discharges fluid through an exit opening in the low static pressure surface.

18. The improved fluid dynamic foil of claim 17 wherein said exit opening in the low static pressure surface is disposed, at least in its majority, aft of mid-span of the improved fluid dynamic foil.

19. The improved fluid dynamic foil of claim 12 wherein a fluid passageway connects the low static pressure surface and a fluid accelerating chamber positioned proximal the rotary element thereby aspirating fluid from the low static pressure surface..

20. In an improved fluid dynamic foil, the improvement comprising:
said improved fluid dynamic foil having a rotary element proximal its forward portion wherein rotation of said rotary element increases fluid velocity over the low static pressure side of the fluid dynamic foil thereby decreasing static pressure further resulting in a higher coefficient of lift for the fluid dynamic foil and wherein fluid energized by the rotary element is directed through a fluid passageway and said fluid passageway connects with an opening in the low static pressure surface.
